(19) United States
(12) Patent Application Publication
(10) Pub. No.: US 2013/0047703 A1
(43) Pub. Date: Feb. 28, 2013

(54) DEVICE FOR MEASURING PARTICULATE CONCENTRATION IN MOTOR VEHICLE EXHAUST GASES

(71) Applicants: Karl Stengel, Deizisau (DE); Gerhard Haaga, Ohmden (DE); Michael Neuendorf, Plochingen (DE); Raymond Sieg, Esslingen (DE)

(72) Inventors: Karl Stengel, Deizisau (DE); Gerhard Haaga, Ohmden (DE); Michael Neuendorf, Plochingen (DE); Raymond Sieg, Esslingen (DE)

(21) Appl. No.: 13/581,284

(22) PCT Filed: Jan. 4, 2011
(86) PCT No.: PCT/EP11/50048

§ 371 Date: Nov. 9, 2012

(30) Foreign Application Priority Data
Feb. 26, 2010 (DE) 102010002424.4

(51) Int. Cl. G01M 15/10

(52) U.S. Cl. 73/23.31

(57) ABSTRACT

A device for measuring a particulate concentration in motor vehicle exhaust gases, has a measuring chamber, which is able to be filled up with a gas-particulate mixture that is to be measured, at least one light source and at least one light sensor. The light sensor detects light that has been scattered by particulates present in the gas-particulate mixture. An exhaust gas supply device is developed to supply exhaust gas, that is to be measured, to the measuring chamber. A null gas low in particulates is able to be supplied from a null gas source to the measuring chamber. A switching element, which is situated between the exhaust gas supply device and the measuring chamber, is suitable for admitting or forestalling the supply of exhaust gas into the measuring chamber on an optional basis.

### FIELD OF THE INVENTION

The present invention relates to a device for measuring particulate concentration in motor vehicle exhaust gases.

### BACKGROUND INFORMATION

For the measurement of particulates in exhaust gases and other colloids, a scattered light method is frequently used, in which the colloid to be measured is guided through a measuring chamber. In this context, for example, a laser is used as a light source in such a way that the light emitted by the light source is scattered by particulates present in the colloid. In addition, at least one light sensor is present, but it is better if a plurality of light sensors are present, which detect the light scattered by the particulates (scattered light). The light sensors may be situated at various angles with respect to the irradiation direction of the light.

In general, the components involved, such as the light source, light sensors and the electronic evaluation circuit of the sensor signals have a variety of offset mechanisms and drift mechanisms, which take place invariantly in time, but very slowly as a rule. These mechanisms include, for instance, a temperature drift of the light power emitted by the light source, a drift of the sensors, a drift of the evaluation circuit, offset variables of these components and aging effects. Beside these measuring errors caused by the electronic components, in the case of scattered light methods, there are still further possible sources of errors. Examples for this are reflections at the measuring geometry, when the light source is switched on, even when there are no particulates located in the measuring chamber, and other signal portions caused by particulates, because the measuring chamber is filled with medium, such as a gas or environmental air, which contains a certain quantity of particulates, even though it is slight in comparison to exhaust gases.

In the case of test devices, that are used in repair shops, the environmental air is often strongly polluted by particulates, and therefore noticeably influence the measuring accuracy.

If the measuring device is to assess the emissions of modern motor vehicles having particulate filters, which have a very low level of emissions, the mechanisms described have, in particular, a great influence on the accuracy of the measurement and the diagnosis.

Thus, there exists a need for eliminating the sources of error described, so as to be able to measure the particulate concentration in motor vehicle exhaust gases at greater accuracy.

### SUMMARY

It is an object of the present invention to provide an emission measuring device for measuring at least one particulate concentration in motor vehicle exhaust gases, using which, the particulate concentration is determinable at high accuracy.

One example device according to the present invention, for measuring the particulate concentration in motor vehicle exhaust gases has a measuring chamber that is able to be filled up with a gas-particulate mixture (colloid), and has at least one light source and at least one light sensor, the light sensor being developed to detect light radiated by the light source and light (scattered light) scattered by the particulates in the gas-particulate mixture. The device according to the present invention also has an exhaust gas supply device and a null gas source. The exhaust gas supply device is developed to guide the exhaust gase to be measured into the measuring chamber. The null gas source is developed so as to supply a null gas low in particulates to the measuring chamber. A switching element, which is situated between the exhaust gas supply device and the measuring chamber, is suitable to admit or forestall the supply of exhaust gas into the measuring chamber on an optional basis.

Using an example device according to the present invention, having a switching element, which is suitable for forestalling the supply of exhaust gas into the measuring chamber, a null calibration may simply be carried out, without, for example, having to pull off and/or reattach hoses. The accuracy of the measuring results ascertained by the measuring device is improved because of the regular carrying out of the null calibration.

Such a device also creates the possibility of carrying out a null calibration of the measuring system automatically, and of thus automatically ensuring the sufficient accuracy of the measuring results.

A switching element, which is situated between the exhaust gas supply device and the measuring chamber, is suitable to admit or forestall the supply of exhaust gas into the measuring chamber on an optional basis. Because the supply of null gas to the measuring chamber during the measuring process is able to be blocked, the measurement is able to be carried out particularly effectively and accurately, since the measurement results are not corrupted by admixed null gas.

In one specific embodiment, the switching element is a change-over element, that is developed in such a way that it forestalls the supply of exhaust gas when it admits the supply of null gas, and admits the supply of null gas when it forestalls the supply of exhaust gas. Because, optionally, exclusively null gas or exclusively exhaust gas is able to be introduced into the measuring chamber, both the null calibration (only null gas in the measuring chamber) and the actual measurement (only exhaust gas in the measuring chamber), are able to be carried out particularly effectively and at high accuracy.

In one specific embodiment, the null gas source has at least one filter. Suitable null gas may be provided particularly cost-effectively using environmental air filtered by a filter.

In one specific embodiment, the null gas source has a two-part filter. A two-part filter, which in particular has a coarse filter and a fine filter situated after the coarse filter, in the direction of flow, is able to filter aspirated environmental air effectively. Maintenance costs are also reduced, since the coarse filter and the fine filter are able to be cleaned or replaced independently of one another, when necessary.

In one specific embodiment, the null gas source has at least one pressure sensor. The pressure of the null gas supplied may be monitored by a pressure sensor, and it may be set suitably via a suitable control device. In addition, the degree of soiling of the filter is able to be determined by determining the pressure drop of the null gas occurring at the filter.

In one specific embodiment, the null gas source has at least one pump. The null gas is able to be conveyed into the measuring chamber especially effectively with the aid of a pump.

In one specific embodiment, the pump is situated after the measuring chamber, in the direction of flow. If the pump is situated downstream from the measuring chamber, after filling up the measuring chamber with null gas, by blocking the supply of null gas and continuing to operate the pump, an underpressure may be generated in the measuring chamber. Since the concentration of particles in a gas is proportional to its pressure, by lowering the pressure, the particle concentration in the measuring chamber is able to be lowered to below the particle concentration in the null gas. Thereby the null level is dropped and the sensitivity of the measuring device is improved.

In one specific embodiment, the null gas source is connected to the measuring chamber in such a way that null gas flowing from the measuring chamber is supplied to the null gas source. Thus a closed circulatory system is created for the null gas, and the null gas is utilized especially effectively. Because the null gas is repeatedly guided in the circulatory system through the filter(s), the particle concentration in the null gas is able to be reduced still further.

In one specific embodiment, the emission measuring unit is equipped so that the null calibration is carried out automatically. It is ensured, by an automatically carried out null calibration, that the measuring device continually supplies sufficiently accurate results, independently of the custom of the user, who might forget to do a manual null calibration or leave it out for convenience sake.

An automatic null calibration may be canceled in each case after a specified number of measurements and/or at specified time intervals. The method may also be arranged so that a null calibration is automatically carried out either when a specified number of measurements has been achieved or when the distance in time between two successive measurements exceeds a specified time interval, depending on which criterion is is satisfied first.

The accuracy of the null point setting thus has only to be ensured over the time period between two successive null calibrations. Measurement errors due to drift mechanisms may thus be reliably prevented or minimized. In the extreme case, a null calibration may be carried out necessarily and automatically before each individual measurement, in order to maintain measuring results having a particularly high accuracy.

Exemplary embodiments of the present invention are described below with reference to the figures.

### BRIEF DESCRIPTION OF THE DRAWINGS

FIG. 1 shows schematically a first exemplary embodiment of a measuring device according to the present invention.

FIG. 2 shows schematically an alternative exemplary embodiment of a measuring device according to the present invention.

FIG. 3 shows schematically a third exemplary embodiment of a measuring device according to the present invention.

### DETAILED DESCRIPTION OF EXAMPLE EMBODIMENTS

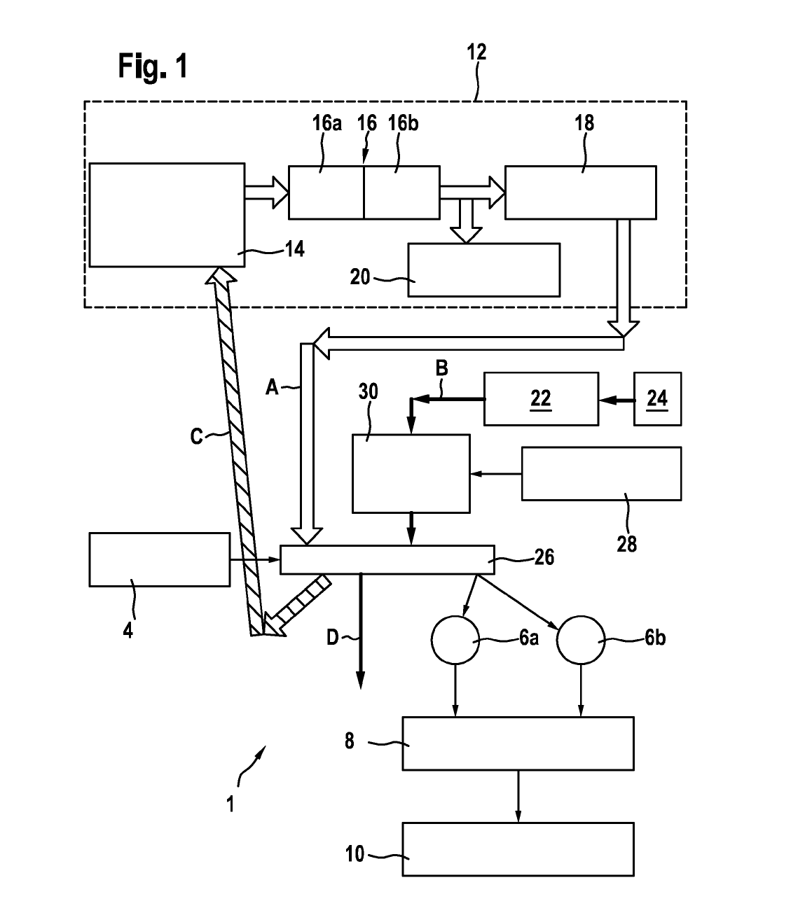

Measuring device 1, shown in FIG. 1, according to a first exemplary embodiment of the present invention has a measuring chamber 26 that has a light source 4, which, for example, is developed as a laser, and radiates light into measuring chamber 26 when in operation. Measuring chamber 26 is equipped with two light sensors 6a, 6b. In the schematic representation of FIG. 1, light sensors 6a, 6b, for reasons of greater clarity, are drawn outside measuring chamber 26, although, in reality, they are at least partially situated within or on measuring chamber 26. Light sensors 6a, 6b record light radiated by light source 4, which has been scattered by particulates present in measuring chamber 26 (scattered light). Light sensors 6a and 6b, in this instance, are preferably situated so that they detect all light scattered at various angles.

Light sensors 6a, 6b are connected to an evaluation unit 8, which evaluates the signals emitted by light sensors 6a, 6b and which, in particular, determines the particulate concentration of the colloid in measuring chamber 26 from the signals emitted by light sensors 6a, 6b. The results of the evaluation are output via an output device 10. Output device 10 may include a display, a printer and/or a data interface, which is developed to transmit the results to a data processing device or a data storage device, such as a disk or a USB stick.

The exhaust gases to be measured, of a schematically shown motor vehicle 24, are picked up by an exhaust gas probe 22, which is situated in or at the exhaust of motor vehicle 24, and are guided by an exhaust gas hose and switching element 30 to measuring chamber 26 (exhaust gas flow B). Upstream of, or downstream from measuring chamber 26, a pump may be provided, that is not shown, in order to support the exhaust gas flow, additionally to the the exhaust gas pressure generated by the motor vehicle 24

Switching element 30 is connected to a control unit 28 and may be switched over between an open state, in which it admits an inflow of exhaust gases from motor vehicle 24 into measuring chamber 26, and a closed state, in which the inflow of exhaust gases from motor vehicle 24 into measuring chamber 26 is switched off. Control unit 28 is connected, for instance, electrically, mechanically or hydraulically to switching element 30, which may be developed as a switching valve, for example.

From measuring chamber 26, the exhaust gases flow outwards, via an exhaust gas removal device, (exhaust gas flow D), without polluting or poisoning the direct surroundings of measuring chamber 26, such as the workshop or the measuring location.

One measuring device 1, according to the present invention, additionally has a null gas source 12, which provides so-called null gas, i.e., gas having a particularly low particle concentration. Null gas source 12 has an air feed 14, which takes up air from the surroundings. If measuring device 1 is being operated in particularly soiled and/or dust-containing surroundings, such as in a workshop, air feed 14 may be developed as a pipe or chimney, to bring in the environmental air from a greater distance, such as from outside the building. Alternatively, particularly clean air may also be taken from delivered gas cylinders.

Air feed 14 supplies the surrounding air taken up to a filtering unit 16, which is developed to reduce the particle concentration in the air taken up. For this, filter unit 16 has at least one fine filter 16b (e.g., a so-called HEPA filter), which is in a position to filter the air supplied to be so clean that the concentration of the particles, which are still contained in the null gas after filtering, is lower than the particulate concentration in the exhaust gases that are output by vehicles having a well-functioning exhaust gas particulate filter.

A coarse filter 16a is preconnected to fine filter 16b, which filters out particularly coarse particulates from the air supplied, before they get to fine filter 16b, and thus it prevents rapid soiling and/or clogging of fine filter 16b. The maintenance intervals for replacing or cleaning filters 16a and 16b may be prolonged thereby. Coarse filter 16a and fine filter 16b, depending on the respective degree of soiling, may also be replaced or cleaned separately. The maintenance costs are able to be reduced by these measures.

Downstream from filter unit 16, a pump 18 is provided, which aspirates environmental air through air supply 14 and filter unit 16 and outputs it to measuring chamber 26 (null gas flow A).

During the course of the air flow between air supply 14 and pump 18, a pressure sensor 20 is provided, which measures the pressure of the air supplied in null gas source 12 and passes on the result to a control unit not shown in FIG. 1. The pressure thus measured may be used for the regulation of pump 18, so as to ensure a sufficient null gas flow A from null gas source 12 into measuring chamber 26.

When the performance of pump 18 is known, from the pressure of the air supplied or from the pressure drop occurring on filter unit 16, one may draw a conclusion as to the degree of soiling of filter unit 16, since a larger pressure drop occurs over a soiled filter unit 16 than over a clean filter unit 16. If the pressure drop over filter unit 16 exceeds a specified boundary value, a warning signal may be output which points out to the user that at least one filter of filter unit 16 should be replaced. Also, in response to the exceeding of a specified boundary value, which is equal to, or higher than the boundary value at which a warning is output, pump 18 may be switched off, when the soiling of filter unit 16 is so great that the certain functioning of null gas source 12 is no longer assured.

In addition, a second pressure sensor 20 may be situated upstream, between air supply 14 and filter unit 16.

In the exemplary embodiment shown in FIG. 1, the null gas that flows from measuring chamber 26 may once more be supplied to air supply 14 (null gas recirculating flow C). This creates a null gas circulating system, in which the null gas is repeatedly guided through filter unit 16. Thereby the particle concentration in the null gas may be reduced even further. Also, the requirement for gas supplied from the outside is reduced, which is particularly advantageous if especially clean, but also costly gas from gas tanks is used as the null gas.

Before the actual measuring process, control unit 28 actuates switching element 30 so that no exhaust gases flow from motor vehicle 24 into measuring chamber 26.

Pump 18 is switched on, so that null gas filtered by filter unit 16 flows from null gas source 12 into measuring chamber 26.

By switching on light source 4 and evaluating the signals output by light sensors 6a, 6b, which are based on the light scattered by particulates in measuring chamber 26 and picked up by light sensors 6a, 6b, a null calibration of measuring chamber 26 is carried out.

After the zero calibration has been carried out, control unit 28 actuates switching element 30 in such a way that the supply of exhaust gases by motor vehicle 24 to measuring chamber 26 is opened, and exhaust gases flow from motor vehicle 24 through the measuring chamber (exhaust gas flow B, C), so that the particulate concentration in the exhaust gases is able to be measured. Alternatively, the switching over of switching element 30 may be performed by the operator. In this case, one may do without a motor, or the like, for switching over switching element 30.

In the exemplary embodiment shown in FIG. 1, null gas flow A is not switched off during the measurement of the particulate concentration in the exhaust gases. The null gas from null gas source 12 flows through measuring chamber 26 simultaneously with the exhaust gases to be measured. In this context, the null gas is guided along, for instance, as scavenging gas directly before sensors 6a, 6b and/or the light exit opening of light source 4, in order to prevent the soiling of sensors 6a, 6b or the light exit opening by the deposition of particulates from exhaust gas flow B.

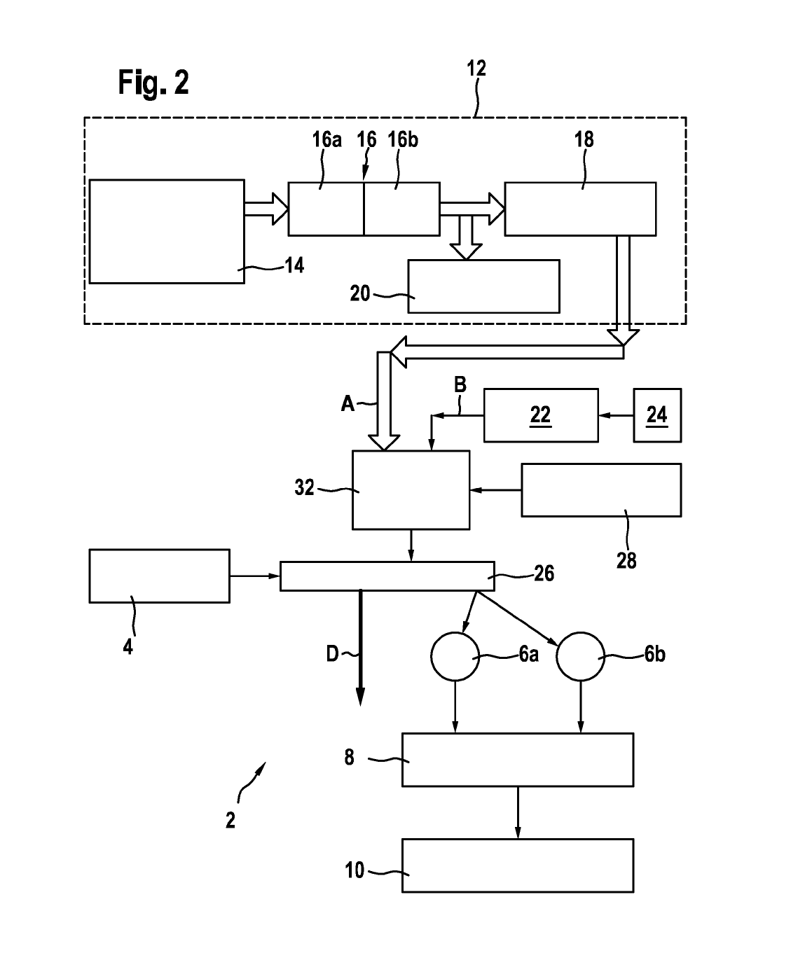

FIG. 2 shows schematically an alternative exemplary embodiment of a measuring device 2 according to the present invention.

The design of this measuring device 2 according to the second exemplary embodiment corresponds generally to the exemplary embodiment shown according to FIG. 1. The same elements are provided with the same reference symbols and, to the extent that they agree in design and function with the first exemplary embodiment, they are not described again.

Measuring device 2, according to the second exemplary embodiment, differs from measuring device 1 of the first exemplified embodiment in that switching element 32 is developed as a switchover element, so that the gas supply into measuring chamber 26 may be optionally switched over between exhaust gases from motor vehicle 24 and null gas from null gas source 12. That is, during the measuring process, when exhaust gases are guided from motor vehicle 24 into measuring chamber 26, to determine the particulate concentration in the exhaust gases, no null gas is flowing from null gas source 12 into measuring chamber 26. Similarly, during the null calibration, when the null gas is being guided from null gas source 12 through measuring chamber 26, no exhaust gas flows through measuring chamber 26.

During the measuring process, because no null gas flows into measuring chamber 26, a dilution of the exhaust gases of motor vehicle 24 in measuring chamber 26 is avoided, and even a slight particulate concentration in the exhaust gases is able to be determined at high accuracy

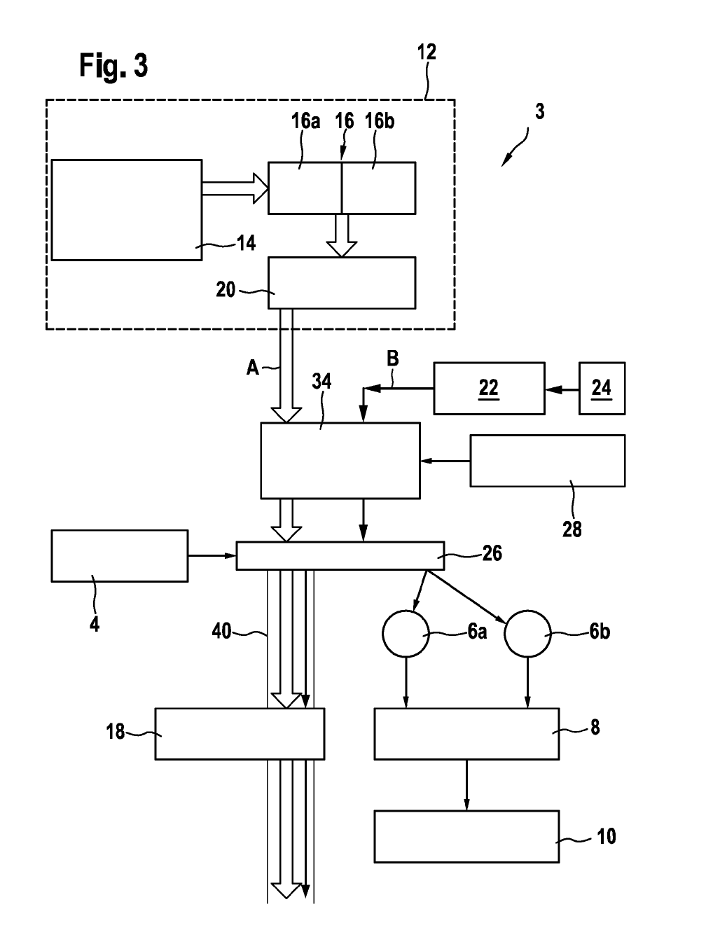

FIG. 3 shows a third exemplary embodiment of a measuring device 3 according to the present invention.

Here too, the elements having the same design and the same functioning as in the previous exemplary embodiments shown, are not described again.

A measuring device 3, according to the third exemplary embodiment, differs from previously shown measuring devices 1, 2 in that pump 18, which is provided for conveying the null gas, is situated not within null gas source 12, upstream of measuring chamber 26, but downstream from measuring chamber 26, in an exhaust gas line 40, which is provided to remove the exhaust gases from measuring chamber 26.

In this exemplary embodiment, pump 18 conveys the null gas from null gas source 12 by suctioning the null gas through measuring chamber 26. At the same time, pump 18, when it is also being operated during the measuring process, supports exhaust gas flow B from motor vehicle 24 through measuring chamber 26.

In the third exemplary embodiment shown in FIG. 3, switching element 34 is developed so that, differently from the second exemplary embodiment shown before, it is able to switch over not only between null gas flow A and exhaust gas flow B, but also has a setting in which both the supply of exhaust gas flow B and the supply of null gas flow A are blocked.

By the simultaneous blocking of the supply of null gas and exhaust gases, at the simultaneous operation of pump 18, an underpressure is able to be produced in the measuring chamber. Since the particle concentration in a gas volume is proportional to its pressure, by lowering the pressure or producing an underpressure in measuring chamber 26, the particulate concentration in measuring chamber 26 is able to be reduced even further. A lower null level of measuring device 3 is thus achieved, and the detection threshold for particulates in exhaust gas flow B is able to be lowered even more. As a result, the accuracy achievable using measuring device 3 is able to be further increased.

Each of measuring devices 1, 2, 3 shown in the three exemplary embodiments according to the present invention may advantageously be developed so that a measurement is carried out only when a null calibration has been carried out before. In particular, measuring devices 1, 2, 3 may be developed so that a null calibration is undertaken automatically before each measurement. This avoids that a necessary null calibration is not carried out, because of forgetfulness or the convenience of the operator, and a measurement is carried out which supplies false measuring results, based on the missing null calibration.

A measuring device, which carries out the null calibration automatically, provides particularly reliable measuring results having the best possible accuracy.

1-10. (canceled)

11. A device for measuring a particulate concentration in motor vehicle exhaust gases, comprising:
a measuring chamber which is able to be filled up with a gas-particulate mixture;
at least one light source and at least one light sensor, the light sensor to detect light scattered by particulates present in the gas-particulate mixture;
an exhaust gas supply device to supply exhaust gas that is to be measured to the measuring chamber;
a null gas source to provide a null gas that is low in particles; and
a switching element situated between the exhaust gas supply device and the measuring chamber, the switching element to admit or forestall a supply of the exhaust gas into the measuring chamber on an optional basis.

12. The device as recited in claim 11, further comprising:
a switching element situated between the null gas source and the measuring chamber to admit or forestall a supply of the null gas into the measuring chamber on an optional basis.

13. The device as recited in claim 12, wherein the switching element situated between the null gas source and the measuring chamber is a change-over element to forestall the supply of exhaust gas into the measuring chamber when it admits the supply of null gas, and admits the supply of null gas into the measuring chamber when it forestalls the supply of exhaust gas.

14. The device as recited in claim 11, wherein the null gas source has at least one filter.

15. The device as recited in claim 11, wherein the null gas source has at least one pressure sensor.

16. The device as recited in claim 11, wherein the device further includes at least one pump.

17. The device as recited in claim 16, wherein the pump is situated before the measuring chamber in a direction of flow.

18. The device as recited in claim 11, wherein the pump is situated after the measuring chamber in the direction of flow.

19. The device as recited in claim 11, wherein the null gas source is connected to the measuring chamber in such a way that the null gas flowing from out of the measuring chamber is conveyed to the null gas source.

20. The device as recited in claim 11, where the device is configured so that a null calibration is carried out automatically.
